(19) United States
(12) Patent Application Publication
(10) Pub. No.: US 2005/0141820 A1
(43) Pub. Date: Jun. 30, 2005

(54) Optoelectric package

(75) Inventors: Mark M. Mariak, Warren, NJ (US); Henry Meehan, Suffern, NJ (US); William S. Ring, Ringoes, NJ (US)

Correspondence Address: TYCO ELECTRONICS CORPORATION, 4550 NEW LINDEN HILL ROAD, SUITE 450, WILMINGTON, DE, 19808, US

(73) Assignee: Tyco Electronics Corporation, Middletwon, PA (US)

(21) Appl. No.: 10/956,548

(22) Filed: Oct. 1, 2004

Related U.S. Application Data
(60) Provisional application No. 60/507,752, filed on Oct. 1, 2003.

(51) Int. Cl. G02B 6/36

(52) U.S. Cl. 385/88

(57) ABSTRACT

An optical connector interface for attachment to a header to form a TO-can assembly, said optical connector interface comprising an integrally-molded body defining a main axis and having first and second ends and comprising at least a ferrule-receiving portion at said first end, said ferrule-receiving portion being adapted to receive a ferrule of an optical connector such that the optical axis of the ferrule is coincident with said main axis, and a cap portion at said second end said cap portion having an optical element mounted therein such that the optical axis of said optical element is coincident with said main axis, said cap portion having a header interface configured for welding to a hearer to form a TO-can.

### CROSS REFERENCE TO RELATED APPLICATIONS

This application is based on U.S. Provisional Application No. 60/507,752, filed Oct. 1, 2003 which is incorporated herein by reference.

### BACKGROUND

A conventional semiconductor laser package is shown in FIG. 6. It comprises a semiconductor laser chip 61 soldered to a sub-mount pedestal 62. The submount pedestal is attached to the header base 63 and electrically connected to contact pin 64. A photodiode 65 mounted on the front surface of the header base 63 detects the optical signal 66 emitted from the back facet 67 of the semiconductor laser. Electrical connections to the semiconductor laser chip 61 and photodiode 65 are provided via bond wires 70 and 71, respectively. The output light beam 68 from the subassembly emerges through a glass window 69 that has been coated with anti-reflection films 72 and 73 to reduce optical loss. The window 69 is attached to a cap structure 74 that is welded to the header base 63 in a hermetic sealing process.

The entire package shown in FIG. 1 comprising the header 63, with mounted semiconductor laser 61, and attached window cap structure 74 is often called a “TO-can” package (TO stands for “transistor outline”). In such a package, the optical beam is emitted parallel to the optical axis of the package which is in a well-defined direction perpendicular to the plane of the header base 63. The position of the optical beam is axially centered on the header base to facilitate positioning and alignment of the beam. The window cap 74 also provides physical protection to the semiconductor laser and enables the entire assembly to be hermetically sealed.

Although this TO-can assembly is shown with a laser, TO-cans can be used to package any of a variety of photonic devices including, for example, lasers, LEDs, and PINs. For example, a “TO-46” type TO-can is used typically for detectors and surface emitting sources (VCSELs) while the “TO-56” type TO-can is typically used for edge-emitter sources (PBH and DFB lasers). This highly successful semiconductor laser package can be found, for example, in compact disk players, laser pointers, and semiconductor laser bar-code scanners.

In telecommunication applications, TO-can assemblies are optically coupled with waveguides, such as fibers, to transmit or receive optical signals along the waveguides. To facilitate this optical coupling, often a sleeve for receiving a ferrule containing a fiber is added to the TO-can. As shown in FIG. 1, this sleeve is attached to the cap 74. The attachment is typically effected by actively alignment the sleeve to the cap and then setting it in place with a UV curable epoxy or similar adhesive.

Although this manufacturing approach has been used for years, it has a number of shortcomings. Perhaps the most significant drawback is the need to align the sleeve to the TO-can, usually by active alignment. Alignment, particularly active alignment, is a time-consuming process. Furthermore, it does not lend itself to automation and, thus, is usually performed by hand and subject to variances and scrapped product.

Therefore, there is a need for a TO-can configuration which simplifies manufacturing and reduces costs. The present invention fulfills this need among others.

### SUMMARY OF INVENTION

The present invention provides for an improved TO-can configuration which eliminates the need to align the sleeve to the cap by using an integrally-molded optical connector interface. Specifically, rather than manufacturing the TO-can first and then attaching the sleeve to the TO-can as is done conventionally, the applicants recognize that it is more efficient to first integrate the connector interface and the cap in a component referred to herein as the optical connector interface (OCI), and then secure this integrated component to the header. In other words, although it is the convention to assemble the TO-can (i.e., the header and the cap) such that a hermetically sealed package is provided before accessorizing it with a ferrule receiving sleeve or other packaging components, by deviating from this approach and, as disclosed herein, incorporate packaging elements in the components before they are assembled into the hermetic TO-can, certain advantages can be realized.

The design and method of the present invention offer a number of advantages over the prior art. First, since the OCI is integrally molded, the alignment of the cap with the sleeve is inherent in the molded product. It is not performed on a per assembly basis. The approach of the present invention therefore not only voids the need to align the sleeve to the cap, but also avoids the need to attach the sleeve to the cap altogether. Furthermore, since the intergrally-molded OCI replaces two discrete pieces, there are fewer parts to inventory and handle. This lowers costs and further simplifies production. Additionally, given the integral nature of the OCI, it can be more readily handled than the smaller cap and sleeve components and, thus, lends itself to automation.

Accordingly, one aspect of the invention is an integrally-molded optical connector interface. In a preferred embodiment, the OCI comprises an integrally-molded body defining a main axis and having first and second ends and comprising at least: (a) a ferrule-receiving portion at the first end, the ferrule-receiving portion being adapted to receive a ferrule of an optical connector such that the optical axis of the ferrule is coincident with the main axis, and (b) a cap portion at the second end the cap portion having an optical element mounted therein such that the optical axis of the optical element is coincident with the main axis, the cap portion having a header interface adapted for welding to a header to form a TO-can assembly.

Another aspect of the invention is a TO-can assembly comprising an integrally-molded optical connector interface. In a preferred embodiment, the TO-can comprises: (a) an optical connector interface comprising an integrally-molded body defining a main axis and having first and second ends and comprising at least: (i) a ferrule-receiving portion at the first end, the ferrule-receiving portion being adapted to receive a ferrule of an optical connector such that the optical axis of the ferrule is coincident with the main axis, and (ii) a cap portion at the second end the cap portion having an optical element mounted therein such that the optical axis of the optical element is coincident with the main axis, the cap portion having a header interface; and (b) a header having a base and a photonic device mounted to the base, the photonic device having an optical axis essentially perpendicular to the base, the header being mounted to the header interface such that the main axis is coincident with the optical axis of the device.

Yet another aspect of the invention is a method of manufacturing a TO-can having an integrally-molded optical connector interface. In a preferred embodiment, the method comprises: (a) providing an integrally-molded OCI, the OCI comprising: an integrally-molded body defining a main axis and having first and second ends and comprising at least a ferrule-receiving portion at the first end, the ferrule-receiving portion being adapted to receive a ferrule of an optical connector such that the optical axis of the ferrule is coincident with the main axis, and a cap portion at the second end the cap portion having an optical element mounted therein such that the optical axis of the optical element is coincident with the main axis, the cap portion having a header interface configured for welding to a hearer to form a TO-can; (b) providing a header, the header comprising a base and at least one photonic device mounted to the base, the photonic device having an optical axis essentially perpendicular to the base; (c) aligning the OCI with the header to effect an alignment position in which the main axis is coincident with the optical axis of the device; and (d) welding the OCI to the base in the alignment position.

### BRIEF DESCRIPTION OF DRAWINGS

FIG. 1 shows a cross section of the optical connector interface of the present invention.

FIG. 2 shows the optical connector interface of FIG. 1 with a cutaway portion revealing the cross section.

FIG. 3 shows detail of a welding feature for securing the optical connector interface to a header.

FIG. 4 shows the TO-can assembly of the present invention with the optical connector interface of FIG. 1 welded to a header.

FIG. 5 shows a perspective exploded view of the TO-can assembly shown in FIG. 4.

FIG. 6 shows a prior art TO-can assembly.

### DETAILED DESCRIPTION

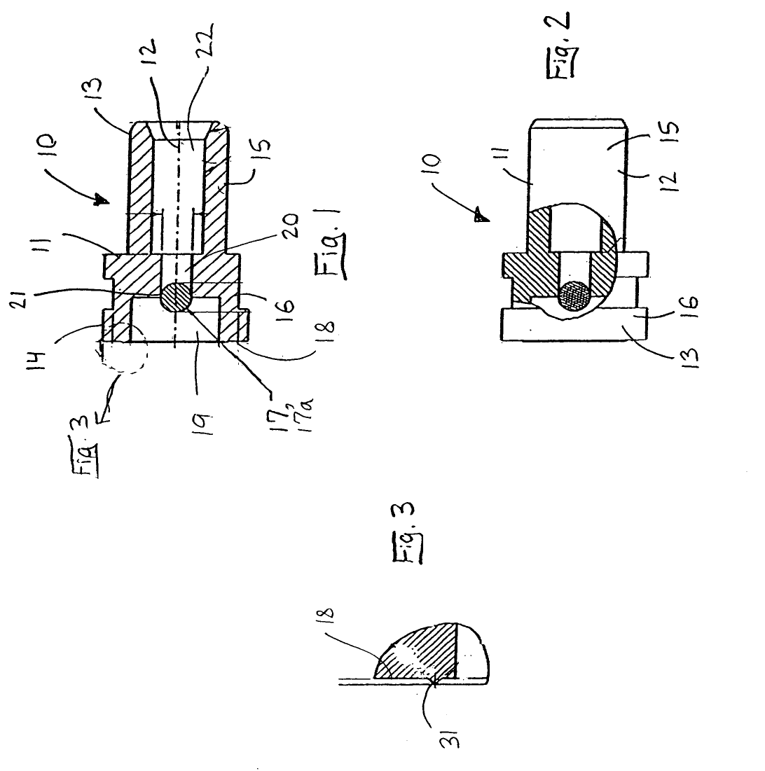

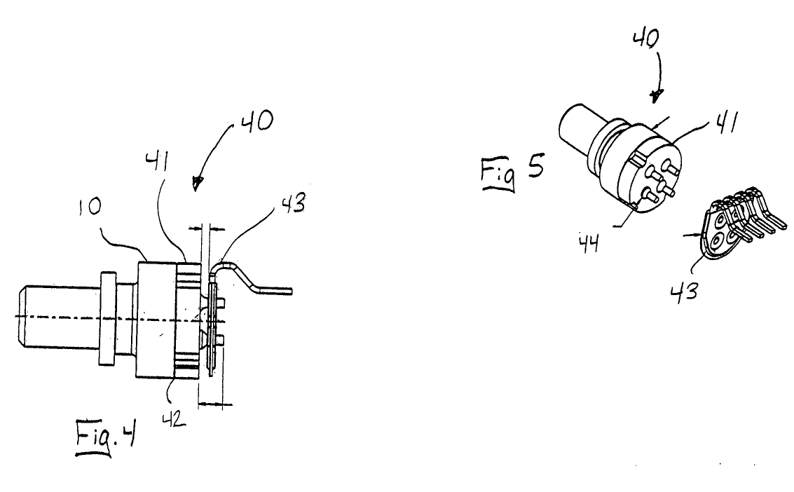

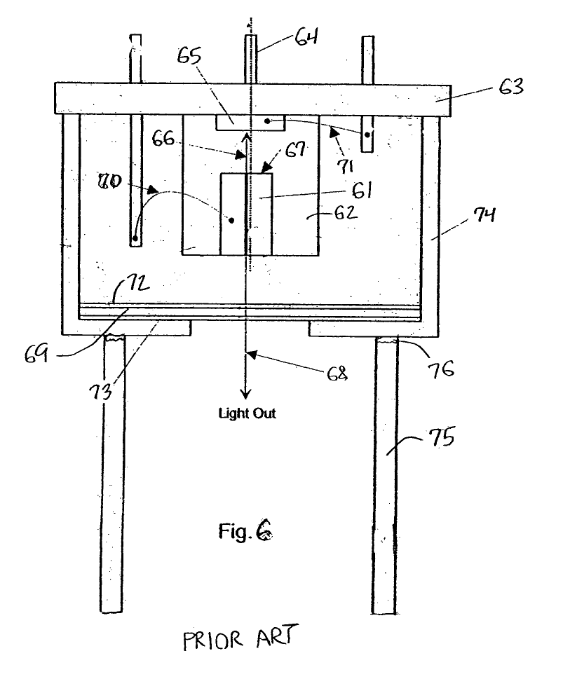

Referring to FIGS. 1 and 2, an optic connector interface (OCI) 10 of the present invention is shown. As shown, the OCI 10 comprises an integrally-molded body 11 defining a main axis 12 and having first and second ends 13, 14. The integrally-molded body 11 comprises at least a ferrule-receiving portion 15 at the first end 13. The ferrule-receiving portion 15 is adapted to receive a ferrule of an optical connector (not shown) such that the optical axis of the ferrule is coincident with the main axis 12. As used herein, the term “coincident” refers to one line being superimposed upon another. The integrally-molded body also comprises a cap portion 16 at the second end 14. The cap portion has an optical element 17 mounted therein such that the optical axis of the optical element is coincident with the main axis 12. The cap portion 16 also has a header interface 18 configured for welding to a header 41 (see FIGS. 4 and 5) to form a TO-can assembly. The features of the OCI 10 are described in greater detail below.

The integrally-molded body 11 may comprise any traditional molded material such as metal, polymer, or ceramic. In a preferred embodiment, the integrally-molded body is formed of metal to allow the use of resistive welding as a means of assembly.

Throughout this description, reference is made to the main axis 12 of the integrally-molded body for purposes of describing the relative radial positions of the features of the OCI and the header to which it is attached. It should be understood, however, that the main axis is for reference purposes and that it does not necessarily run down the center of the integrally-molded body 11, although preferably it does.

The ferrule-receiving portion 15 located at the first end is shown to be a cylindrical sleeve, however, it can be any shape providing that it has a cavity 22 configured to accommodate a ferrule, including, for example, rectangular cavity. The cavity 22 of the ferrule-receiving portion is closely toleranced to hold the ferrule precisely and restrict its radial movement therein. Preferably, the cavity of the ferrule-receiving portion has a diameter which is no more than about 0.4% or mm wider than the ferrule. This way, the optical axis of the ferrule is precisely positioned coincident with the main axis 12 of the integrally-molded body 11.

The cap portion 16 of the integrally-molded body is located at the second end 14 and serves to enclose the header and provide a hermetic package for the TO-can. The cap portion is preferably configured to have a U-shaped cross section with top edge of the U being the header interface 18. The interior 19 of the cap portion should be large enough to enclose the photonic device(s) mounted to the header. The cap portion has a window 20 for allowing optical signals to pass through.

In the window 20 contains the optical element 17 which preferably serves two functions. First, it serves to seal the window 20 to provide a hermetically sealed TO-can as defined by the header and the cap portion 16. Accordingly, the optical element 17 should be formed from a material known for its hermetic sealing properties such as glass. Second, it should optically couple the light between the fiber and the photonic device mounted in the header. According, the optical element may be any conventional optical device for coupling light including, for example, a lens, such as a ball lens, or a simple planar transparent surface. The type and configuration of the appropriate optical element should be apparent to those of skill in the art. As shown, in FIG. 3, the optical element 17 is a ball lens 17a secured to the inner surface of window 20. The ball lens 17a seats on a rounded edge 21 of the window 20 to precisely position the ball lens within the OCI 10.

Referring to FIG. 3, details of the OCI's welding features are shown. In particular, a protrusion 31 is shown on the header interface 18 of the OCI 10. The protrusion 31 facilitates welding the OCI to the header by providing the welding material necessary to joint the two components. The details of the welding process are considered in more detail below.

Referring to FIGS. 4 and 5, a completed TO-can assembly 40 connected to a portion of flexible circuit 43 is shown in a side view and an exploded perspective view, respectively. The TO-can assembly 40 is shown with the OCI 10 welded to the header 41. As used herein, the term “TO-can assembly” refers to an assembly of the header, cap and ferrule receiving interface and differs from the term “TO-can” which refers only to an assembly of the header and cap. The header is a conventional header comprising a base 42 having a photonic device (not shown) mounted to it. The photonic device may be adapted for either receiving or transmitting signals. Such photonic devices are well-known in the art and include for example, lasers, LEDs, and PINs. Details of these devices will not be considered herein in detail aside from mentioning that these devices have an optical axis which is essentially perpendicular to the base.

The TO-can assembly 40 shown in FIGS. 4 and 5 is a receiving optical subassembly or ROSA. Preferably, the OCI of the present invention is used in ROSA applications since, unlike transmitting optical subassemblies (TOSAs), it is not critical to precisely align the optical element contained in the OCI along the main axis 12 with respect to the focal point of the photonic device. Rather, adequate focal point alignment can be achieved passively by precisely molding the OCI to control the distance between the header interface surface 18 and the ball lens 17a.

The TO-can assembly has a number of pins 44 extending from the base for connection to an electrical interface, which, in this embodiment, is a flexible foil circuit 42. The flex circuit is well-known and is used to interface the TO-can to the system is which it is mounted.

The process of welding the OCI to the header is performed using known techniques. Specifically, the process begins with providing an integrally-molded OCI as described above and a header. Next, the OCI is aligned radially with respect to the header to effect an aligned position wherein the main axis of the OCI is coincident with the optical axis of the header. While holding the components in the aligned position, the header interface of the OCI is welded to the base of the header. It is worthwhile to note that, unlike prior art, there is no step requiring the ferrule-receiving portion to be separately aligned and secured to the cap portion. This, of course, is inherent in the integrally-molded OCI.

The step of aligning the OCI to the header can be accomplished either actively or passively. If performed passively, it is generally preferred that the header and interface surface of the OCI have fiducials that interact to achieve this alignment. Such fiducials may include, for example, alignment pins and receiving holes or register surfaces against which the components can contact. For example, the header may comprise an annular ring against which the cap portion would contact to register the radial position of the cap portion relative to the base.

The step of welding the OCI to the header comprises resistive welding, whereby the introduction of a large current with simultaneous application of force to the weld projection causing the cap to be joined with the header. Alternatively the lens cap can be welded to the header using a Nd-Yag laser at the circumferential interface of the two components. Welding the OCI to the header lends itself to automation given the shape and size of the OCI relative to the discrete cap portion and sleeve components in the prior art. Furthermore, if interacting passive alignment fiducials are incorporated into the OCI and header, even a higher degree of automation may be realized in the TO-can assembly of the present invention.

Therefore, the OCI the present invention provides for a simplified TO-can assembly having more consistent performance while reducing the number of manufacturing steps and facilitating automated assembly.

1. An optical connector interface for attachment to a header to form a TO-can assembly, said optical connector interface comprising: an integrally-molded body defining a main axis and having first and second ends and comprising at least:
a ferrule-receiving portion at said first end, said ferrule-receiving portion being adapted to receive a ferrule of an optical connector such that the optical axis of the ferrule is coincident with said main axis, and
a cap portion at said second end said cap portion having an optical element mounted therein such that the optical axis of said optical element is coincident with said main axis, said cap portion having a header interface configured for welding to a hearer to form a TO-can.

2. The optical connector interface of claim 1, wherein said integrally-molded body is formed of metal.

3. The optical connector interface of claim 1, wherein said ferrule-receiving portion is cylindrical.

4. The optical connector interface of claim 1, wherein said optical element is a ball lens.

5. The optical connector interface of claim 1, wherein said cap portion comprises a window leading to said ferrule-receiving portion.

6. The optical connector interface of claim 1, wherein said header interface comprises a welding protrusion.

7. A TO-can assembly comprising:
an optical connector interface comprising an integrally-molded body defining a main axis and having first and second ends and comprising at least:
a ferrule-receiving portion at said first end, said ferrule-receiving portion being adapted to receive a ferrule of an optical connector such that the optical axis of the ferrule is coincident with said main axis, and
a cap portion at said second end said cap portion having an optical element mounted therein such that the optical axis of optical element is coincident with said main axis, said cap portion having a header interface; and
a header having a base and a photonic device mounted to said base, said photonic device having an optical axis essentially perpendicular to the base, said header being mounted to said header interface such that said main axis is coincident with said optical axis of said device.

8. The TO-can assembly of claim 7, wherein said photonic device is a receiving device.

9. The TO-can assembly of claim 7, wherein said photonic device is a photodiodes.

10. The TO-can assembly of claim 7, wherein said TO-can assembly is a TO-56 type.

11. The TO-can assembly of claim 7, wherein said header and said cap portion form a hermetic enclosure for said photonic device.

12. The TO-can assembly of claim 7, wherein said ferrule-receiving portion is cylindrical.

13. The TO-can assembly of claim 7, wherein said optical element is a ball lens.

14. The TO-can assembly of claim 7, wherein said header interface comprises a welding protrusion.

15. A method of manufacturing a TO-can assembly comprising:
providing an integrally-molded optical connector interface, said optical connector interface comprising: an integrally-molded body defining a main axis and having first and second ends and comprising at least a ferrule-receiving portion at said first end, said ferrule-receiving portion being adapted to receive a ferrule of an optical connector such that the optical axis of the ferrule is coincident with said main axis, and a cap portion at said second end said cap portion having an optical element mounted therein such that the optical axis of optical element is coincident with said main axis, said cap portion having a header interface configured for welding to a hearer to form a TO-can.
providing a header, said header comprising a base and at least one photonic device mounted to said base, said photonic device having an optical axis essentially perpendicular to said base;
aligning said optical connector interface with said header to effect an alignment position in which said main axis is coincident with said optical axis of said device; and
welding said optical connector interface to said base in said alignment position.

16. The method of claim 15, wherein said alignment is performed passively.

17. The method of claim 15, wherein said alignment is performed actively.

18. The method of claim 15, wherein said welding comprises laser welding.
